(19) United States
(12) Patent Application Publication
(10) Pub. No.: US 2025/0348093 A1
(43) Pub. Date: Nov. 13, 2025

(54) METHODS AND SYSTEMS FOR COORDINATED MOTION OF VEHICLES

(71) Applicant: Oshkosh Corporation, Oshkosh, WI (US)

(72) Inventor: Devin Rosencrance, Oshkosh, WI (US)

(73) Assignee: Oshkosh Corporation, Oshkosh, WI (US)

(21) Appl. No.: 19/086,807

(22) Filed: Mar. 21, 2025

Related U.S. Application Data
(60) Provisional application No. 63/643,617, filed on May 7, 2024.
(60) Provisional application No. 63/643,788, filed on May 7, 2024.
(60) Provisional application No. 63/643,627, filed on May 7, 2024.
(60) Provisional application No. 63/643,653, filed on May 7, 2024.
(60) Provisional application No. 63/643,723, filed on May 7, 2024.
(60) Provisional application No. 63/643,631, filed on May 7, 2024.
(60) Provisional application No. 63/643,528, filed on May 7, 2024.
(60) Provisional application No. 63/643,541, filed on May 7, 2024.
(60) Provisional application No. 63/643,608, filed on May 7, 2024.
(60) Provisional application No. 63/712,023, filed on Oct. 25, 2024.
(60) Provisional application No. 63/712,662, filed on Oct. 28, 2024.
(60) Provisional application No. 63/712,621, filed on Oct. 28, 2024.
(60) Provisional application No. 63/712,602, filed on Oct. 28, 2024.
(60) Provisional application No. 63/712,647, filed on Oct. 28, 2024.
(60) Provisional application No. 63/741,768, filed on Jan. 3, 2025.
(60) Provisional application No. 63/741,710, filed on Jan. 3, 2025.
(60) Provisional application No. 63/775,273, filed on Mar. 20, 2025.

(51) Int. Cl. G05D 1/698; G05D 1/246; G05D 1/622; G05D 1/693; G05D 1/695; G05D 107/70

(52) U.S. Cl. CPC G05D 1/6987; G05D 1/2469; G05D 1/622; G05D 1/695; G05D 1/693; G05D 2107/70

(57) ABSTRACT

A system includes a first vehicle and a second vehicle coupled with each other, the first vehicle and second vehicle configured to support a load. The system also includes one or more memory devices storing instructions thereon, that, when executed by one or more processors, cause the one or more processors to obtain one or more locations in a floorplan of a production system. The instructions also cause the one or more processors to obtain a route for the first vehicle and the second vehicle, from a first current position of the first vehicle and a second current position of the second vehicle to the one or more locations and generate a series of coordinated motions between the first vehicle and the second vehicle based on the route.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (1) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

An exemplary embodiment relates to a system including a first vehicle and a second vehicle coupled with each other, the first vehicle and second vehicle configured to support a load. The system also includes one or more memory devices storing instructions thereon, that, when executed by one or more processors, cause the one or more processors to obtain one or more locations in a floorplan of a production system. The instructions also cause the one or more processors to obtain a route for the first vehicle and the second vehicle, from a first current position of the first vehicle and a second current position of the second vehicle to the one or more locations and generate a series of coordinated motions between the first vehicle and the second vehicle based on the route.

Another exemplary embodiment relates to method. The method includes obtaining one or more locations in a floorplan of a production system. The method also includes obtaining a route for a first vehicle and a second vehicle from a current position to the one or more locations, the first vehicle and the second vehicle coupled with each other and configured to support a load. The method also includes generating a series of coordinated motions between the first vehicle and the second vehicle based on the route. Additionally, the method includes controlling the first vehicle and the second vehicle to perform the series of coordinated motions along the route to transport the load to the one or more locations.

An additional exemplary embodiment relates to a system including a first vehicle and a second vehicle. The system also includes one or more memory devices storing instructions thereon, that, when executed by one or more processors, cause the one or more processors to determine a load route for a load supported by the first vehicle and the second vehicle between a first position and a second position. The instructions also cause the one or more processors to generate a first vehicle route for the first vehicle based on the load route and a second vehicle route for the second vehicle based on the load route. The motion of the first vehicle along the first vehicle route and the second vehicle along the second vehicle route results in the load moving along the load route.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle, according to an exemplary embodiment;

FIG. 2 is a top view of the vehicle of FIG. 1;

FIG. 3 is a perspective view of the vehicle of FIG. 1 equipped with a lifting implement, according to an exemplary embodiment;

FIG. 4 is a perspective view of the vehicle of FIG. 3 and another vehicle cooperating to support a manufacturing component, according to an exemplary embodiment;

FIG. 5 is a perspective view of the vehicle of FIG. 1 equipped with a cart implement, according to an exemplary embodiment;

FIG. 6 is a perspective view of the vehicle of FIG. 3 interfacing with a cart supporting a manufacturing component, according to an exemplary embodiment;

FIG. 7 is a block diagram of a control system for the vehicle of FIG. 1;

FIG. 8 is a top view of a production system including the vehicle of FIG. 1, according to an exemplary embodiment;

FIG. 9 is a block diagram of a control system for the vehicle of FIG. 7, with a pathing generation system, according to an exemplary embodiment;

FIG. 10 is a top down view of a production system including a vehicle with the pathing generation system of FIG. 9, according to an exemplary embodiment;

FIG. 11 is a top down view of a production system including a vehicle with the pathing generation system of FIG. 9, according to an exemplary embodiment;

FIG. 12 is a top down view of a production system including a vehicle with the pathing generation system of FIG. 9, according to an exemplary embodiment;

FIG. 13 is a top down view of a production system including a vehicle with the pathing generation system of FIG. 9, according to an exemplary embodiment;

FIG. 14 is a top down view of a production system including a vehicle with the pathing generation system of FIG. 9, according to an exemplary embodiment;

FIG. 15 is a flow diagram of a process of the pathing generation system of FIGS. 9-14, according to an embodiment;

FIG. 16 is a block diagram of a coordinated motion system for a vehicle, according to an exemplary embodiment;

FIG. 17 is a block diagram of a control system for the vehicle of FIG. 7, with a coordinated motion system, according to an exemplary embodiment;

FIG. 18 is top down view of a production system including a vehicle with the coordinated motion system of FIG. 17, according to an exemplary embodiment;

FIG. 19 is a top down view of a production system including a vehicle with the coordinated motion system of FIG. 17, according to an exemplary embodiment;

FIG. 20 is a top down view of a production system including a vehicle with the coordinated motion system of FIG. 17, according to an exemplary embodiment; and

FIG. 21 is a flow diagram of a process of the coordinated motion system of FIGS. 16-20, according to an exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a system includes a first vehicle, a second vehicle coupled to the first vehicle, and a load supported by the first vehicle and the second vehicle. The system also includes one or more input devices and one or more memory devices storing instructions thereon. When executed by one or more processors, the instructions cause the one or more processors to retrieve, from the one or more memory devices, a floorplan of a production system and receive a first current position of the first vehicle and a second current position of the second vehicle, and receive, from the one or more input devices, one or more inputs. The one or more inputs include one or more of one or more locations in the production system, a footprint of the first vehicle, the second vehicle, and the load, or one or more obstacles. The instructions also cause the one or more processors to retrieve a route for the first vehicle and the second vehicle, from the first current position of the first vehicle and the second current position of the second vehicle to the one or more locations based on the one or more inputs and generate a series of coordinated motions between the first vehicle and the second vehicle based on the route and the one or more inputs.

### Overall Vehicle

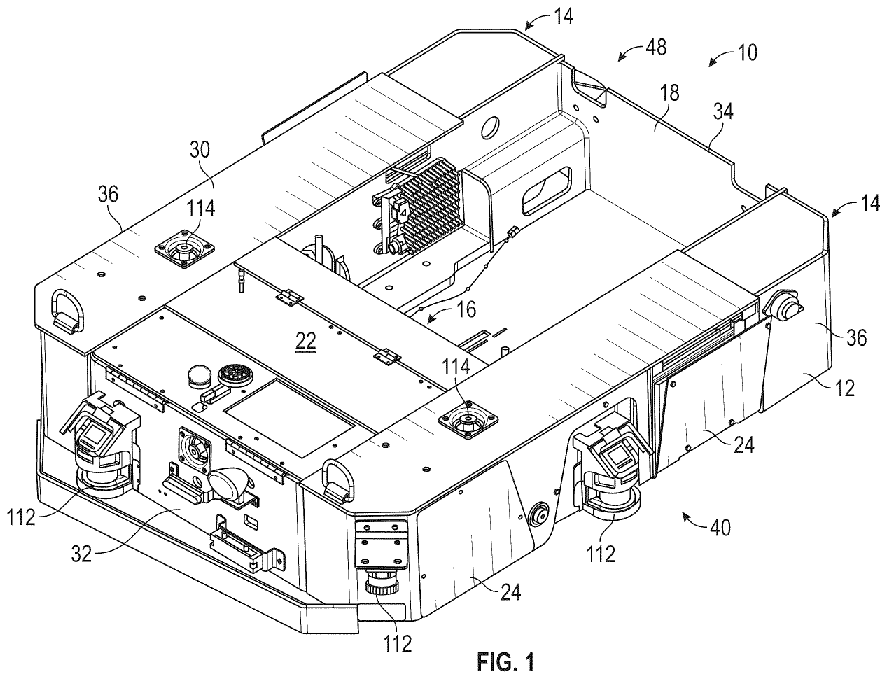

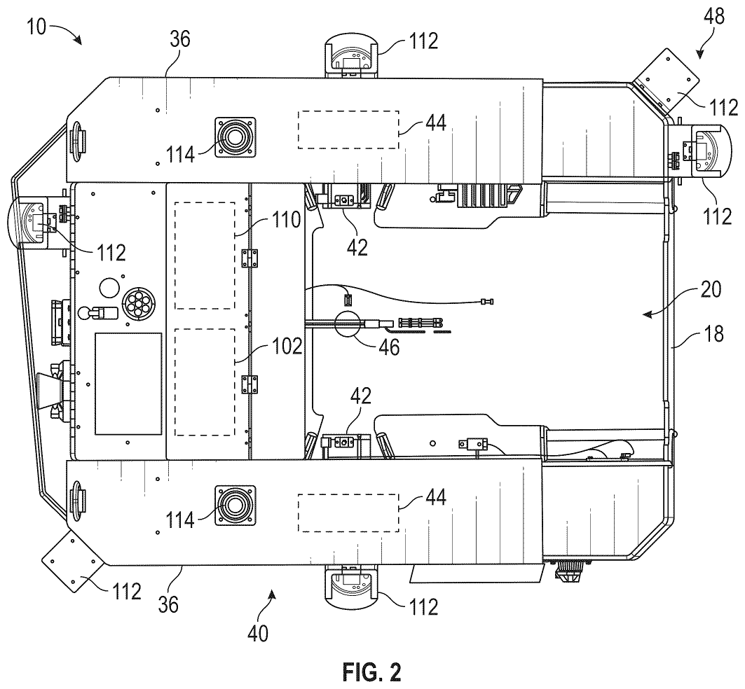

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 40 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

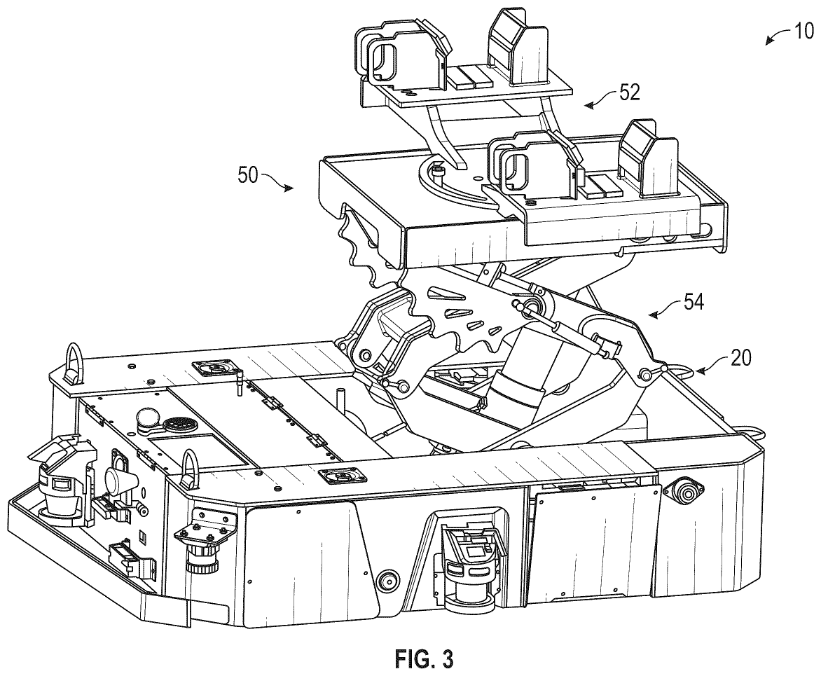

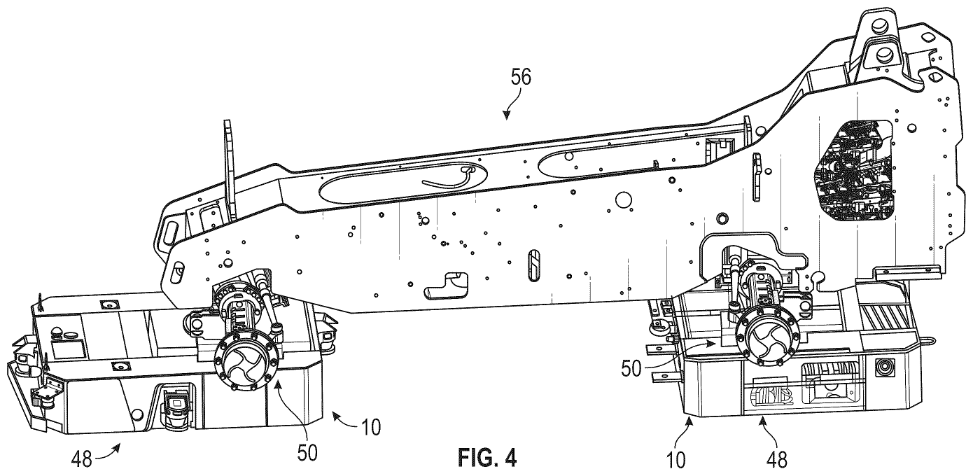

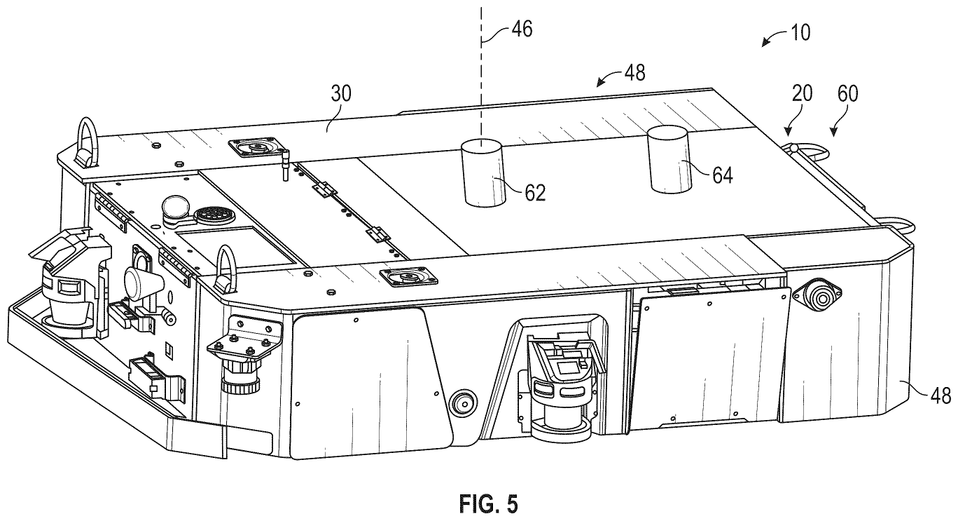

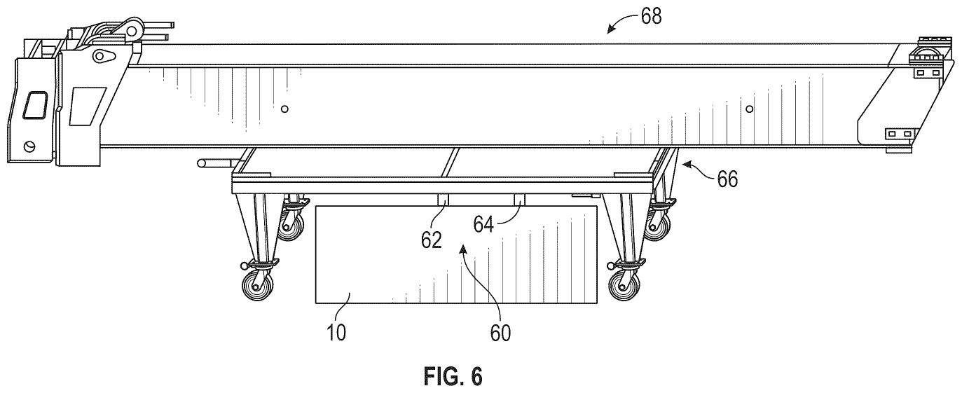

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be rotatably fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

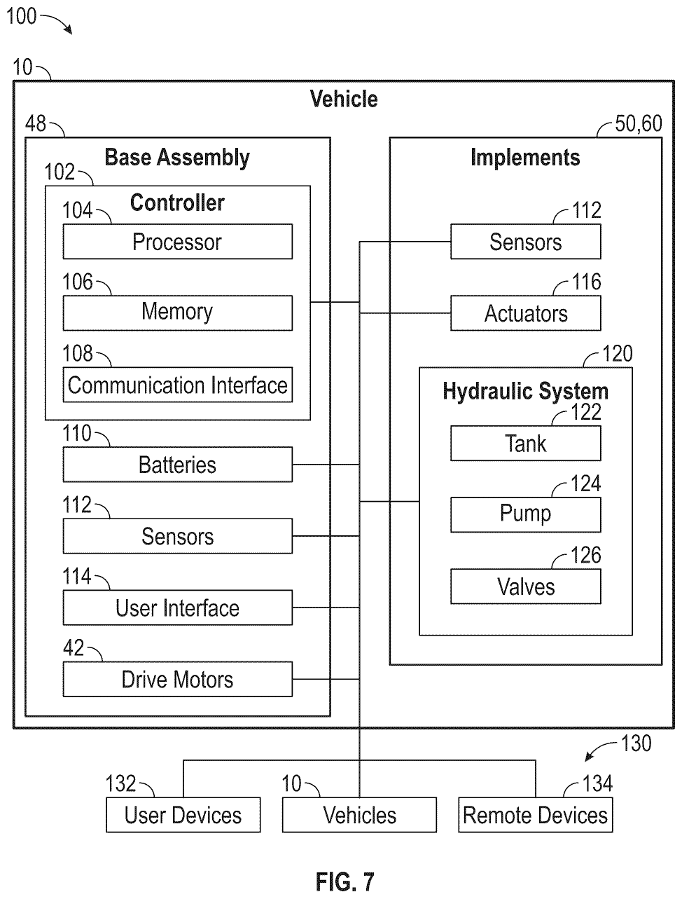

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. They hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

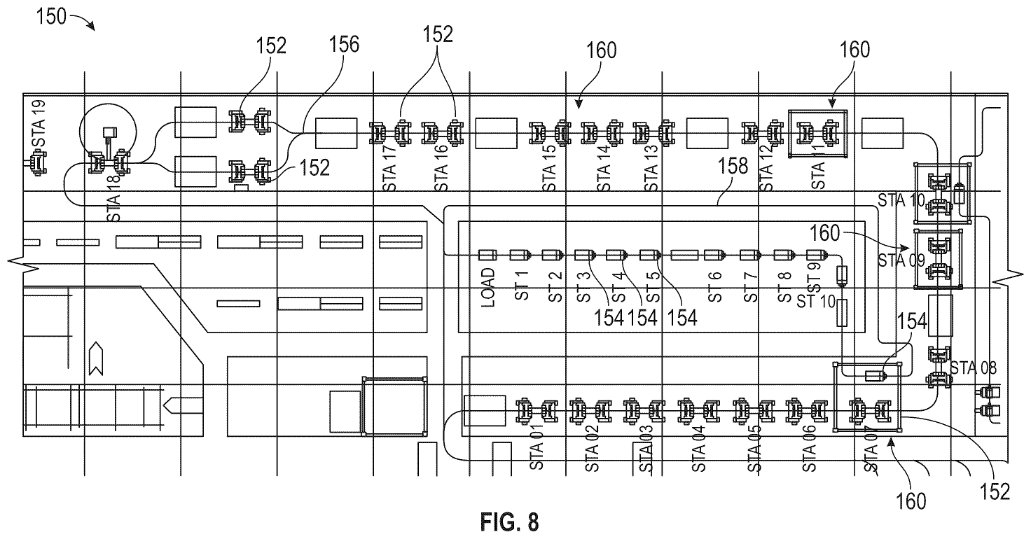

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Pathing Generation System

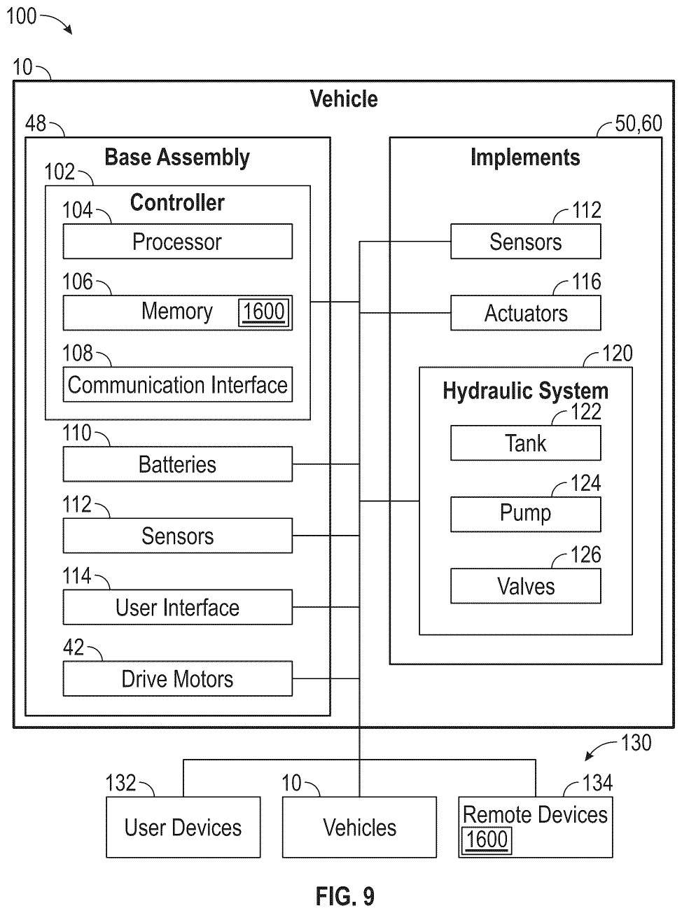

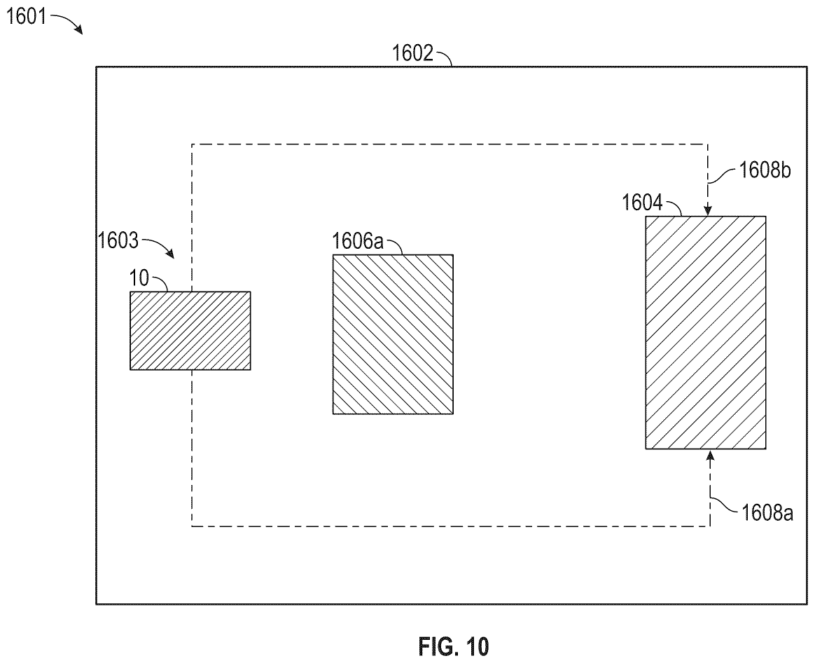

Referring now to FIG. 9, the vehicle 10 and the various components and systems of the vehicle 10 may include a pathing generation system, shown as pathing generation system 1600. Turning now to FIG. 10, the vehicle 10 is shown in a manufacturing environment or production system 1601. Prior to operation of the vehicle 10, a floorplan 1602 (e.g., a layout, etc.) of the production system 1601 may be uploaded to the pathing generation system 1600, such as to the memory 106. A target location 1604 is also shown within the production system. The target location 1604 may be a station (e.g., the station 160) or another area to which the vehicle 10 may need to travel, referred to herein as a target location. The floorplan 1602 may include one or more of the target locations 1604, as well as any other relevant details regarding the layout of the production system 1601. An outer boundary of the floorplan 1602, as depicted in FIGS. 10-15, may serve to represent one or more walls of the production system 1601, another boundary such as an operational boundary of the vehicle 10, or may not have any such bounding significance.

The production system 1601 may include one or more obstacles (e.g., shown in FIG. 10 as obstacle 1606a) such as another station, an object, a machine, a person, an egress point, a staircase, etc. The obstacle 1606a may be in a direct path between the vehicle 10 and the location 1604. As such, the vehicle 10 may need to travel in a path around the obstacle 1606a. The obstacle 1606a may be included in the floorplan 1602 provided to the vehicle 10. In some embodiments, the vehicle 10 may detect the obstacle 1606a (and the target location 1604) via the sensors 112. Once the floorplan 1602 of the production system 1601 is retrieved from the memory 106, the pathing generation system 1600 may generate one or more possible paths for the vehicle 10 to take from an initial location of the vehicle 10 to the location 1604. The pathing generation system 1600 may be in communication with one or more input devices. An operator may use the input device to view and edit the possible paths generated by the pathing generation system 1600 for the vehicle 10 or one or more characteristics of the possible paths such as start points, milestones, and endpoints. For example, the generated possible paths may not take into account the obstacle 1606a, for various reasons. The obstacle 1606a may be movable or not permanent, and therefore may not always be in the same current location. The operator can edit the floorplan 1602 to include one or more of the obstacles 1606a if the obstacle 1606a is not already accounted for in the floorplan 1602.

Once the operator has edited the floorplan 1602 to include the obstacle 1606a, if necessary, the pathing generation system 1600 may generate one or more routes, such as route 1608a and route 1608b, of possible paths from the current location 1603 of the vehicle 10 to the target location 1604. As shown in FIG. 10, there may be one or more paths that the vehicle 10 could take to circumvent the obstacle 1606a. In some embodiments, there may be only on possible path for the vehicle 10, or in other embodiments, there may be many possible paths for the vehicle 10. In the embodiment of FIG. 10, the route 1608a and the route 1608b are substantially the same. For example, the route 1608a and the route 1608b may be substantially the same distance, it may take the vehicle 10 substantially the same amount of time to traverse the route 1608a and the route 1608b, the route 1608a and the route 1608b may have substantially the same rate of efficiency, etc. In such a scenario, it may not matter whether the vehicle 10 travels the route 1608a or the route 1608b. The pathing generation system 1600 may automatically pick either the route 1608a or the route 1608b, or the operator may manually choose between the route 1608a or the route 1608b. In some embodiments, one or more characteristics of the route 1608a may be different from one or more characteristics of the route 1608b, and the pathing generation system 1600 may compare one or more characteristics of the route 1608a may be different from one or more characteristics of the route 1608b to select a preferred route. The one or more characteristics may include a travel time, a distance, a number of obstacles along the route, a number of waypoints along the route, a number of required changes in direction along the route, and/or a factor of safety along the route. The factor of safety may be a metric based on a footprint of the vehicle 10 and any load it may be moving as compared to the maximum allowable dimension of the route. A route with a higher factor of safety may have a greater difference between the maximum footprint of the vehicle 10 and/or any load it may be moving and the maximum allowable dimensions of the route, such that vehicle 10 can travel along a route with a lower likely of accidentally contact with obstacles 1606a in along the route.

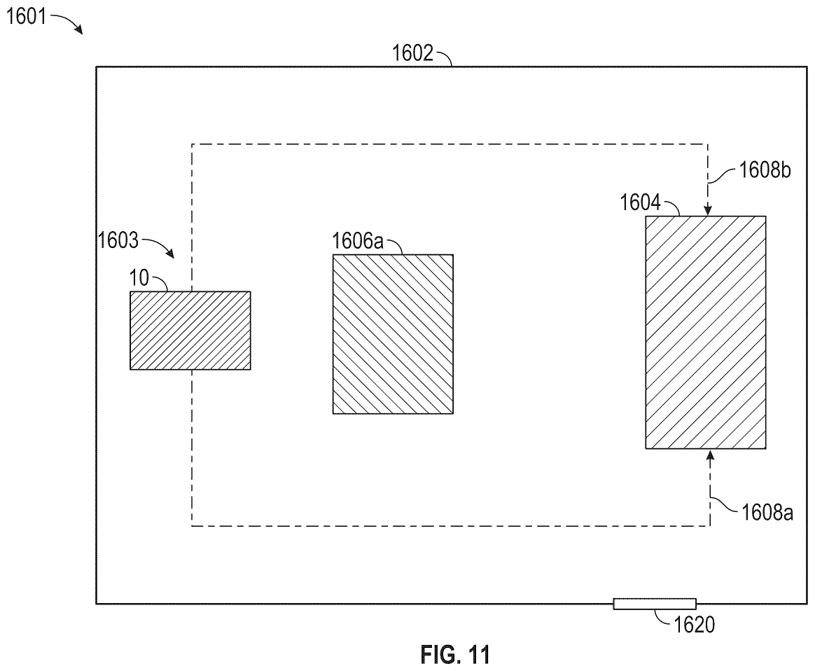

As shown in FIG. 11, in some embodiments, the production system 1601 may include a feature 1620. The feature 1620 may be, for example, an egress point, a staircase, a window, a sign, a wall marking, a person, etc. While it may be difficult for the vehicle 10 to run into, run over, or become blocked by the feature 1620, it may nevertheless be desirable to prevent the vehicle 10 from traveling near or in close proximity to the feature 1620 for various reasons, for example, to avoid blocking an egress point, a staircase, a window, a sign, a wall marking, etc., or to avoid the vehicle 10 getting in the way of a person. Similar to the process for the obstacle 1606a, an operator may add the feature 1620 to the floorplan 1602 if the feature 1620 is not already accounted for in the floorplan 1602, or the features 1620 may be sensed by the sensors 112 of the vehicle 10. In the embodiment of FIG. 11, although the route 1608a and the route 1608b are still substantially the same, the route 1608a may be less preferable because it passes near the feature 1620. As such, the pathing generation system 1600 may be configured to automatically prefer the route 1608b to avoid any potential issues with the feature 1620, or the operator may manually choose the route 1608b.

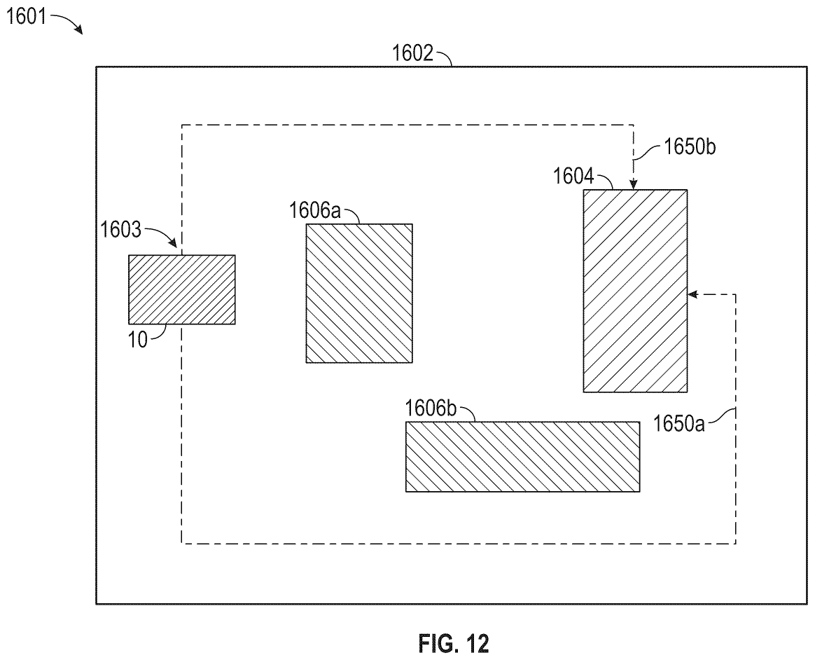

In the embodiment of FIG. 12, an obstacle 1606b is shown within the production system 1601. As previously discussed, the obstacle 1606b may already appear in the floorplan 1602 retrieved by the pathing generation system 1600, or an operator may add the obstacle 1606b into the floorplan 1602, or the obstacle may be sensed by the sensors 112. The pathing generation system 1600 may generate a route 1650a and a route 1650b. As shown in FIG. 12, the route 1650a may be at least somewhat longer in distance and/or more cumbersome for the vehicle 10 than the route 1650b, resulting in lower efficiency. As such, the route 1650b may be preferable over the route 1650a. The route 1650a may also enter the target location 1604 at a different point than the route 1650b, which may result in further inefficiencies, or may not matter in some situations. The pathing generation system 1600 may be configured to automatically prefer the most efficient route (e.g., the shortest or fastest route, etc.), for example, the route 1650b, or the operator may manually choose the route 1650b.

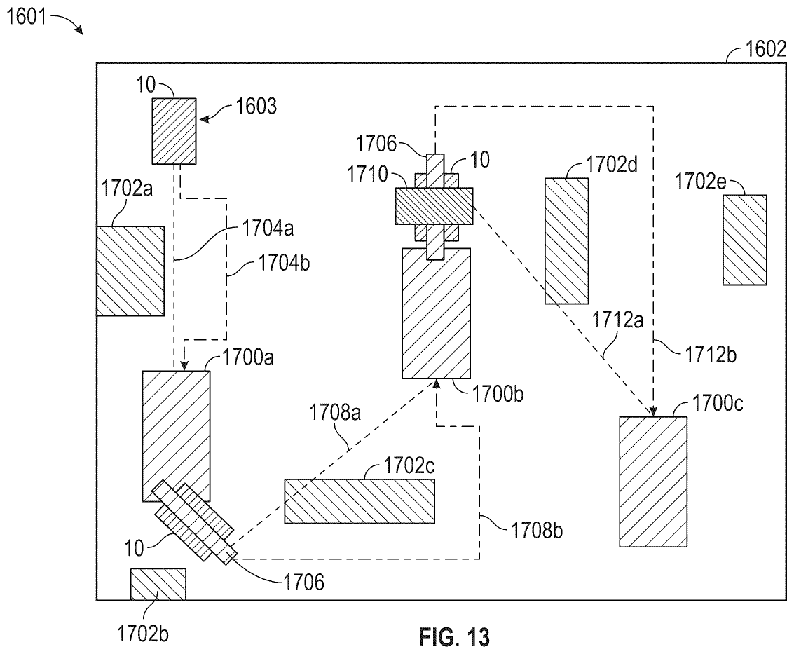

Turning now to FIG. 13, an exemplary embodiment of the production system 1601 is shown. It should be noted that the components and systems as shown in FIG. 13 serve to provide only a non-limiting example and that configurations of the production system 1601 may be utilized. The production system 1601 may include a target location 1700a, a target location 1700b, and a target location 1700c. An operator may use the input device to provide an indication of which locations the vehicle 10 should visit, and in which order. The indications may be saved into a plan which may be uploaded to the memory 106 for future use. An operator may be able to access saved plans for reuse with the floorplan 1602. The pathing generation system 1600 may then generate possible paths for the vehicle 10, and the operator may view and edit the possible paths.

As described further herein, route 1704a, route 1708b, and route 1712a depict the most efficient path (e.g., the shortest or fastest path, etc.) between two points (e.g., the vehicle 10 and a location), without regard to any potential obstacles between the two points. The route 1704a, the route 1708b, and the route 1712a are depicted as dashed lines to indicate a reference path for greater understanding of the embodiments disclosed herein, although the route 1704a, the route 1708b, and the route 1712a may not appear as possible paths or generated routes on the user interface or to an operator of the pathing generation system 1600.

The pathing generation system 1600 may generate the routes 1704 based one or more characteristics of the vehicle 10 and/or the load being moved by the vehicle 10. The one or more characteristics can include a capacity of the vehicle 10, a weight of the vehicle 10 and/or the load, a size or envelope of the vehicle 10, a size of the load (e.g., telchandler 56), a desired distance between the vehicle 10 or the load and an obstacle, or other characteristics of the vehicle 10 and/or the load. The size or footprint of the vehicle 10 (e.g., a length, width, and height) which defines outer boundaries of the vehicle 10 may be predetermined or may be measured by one or more sensors. For example, the vehicle 10 may be a predetermined and is known to the pathing generation system 1600. In some embodiments, the footprint of the vehicle 10 may be monitored and/or measured by one or more cameras, sensors, etc., during various stages of operation of the vehicle 10 within the production system 1601. In some embodiments, the footprint of the vehicle 10 may be determined based on a current stage of assembly of the product being moved by the vehicle 10. The current stage can be determined by a weight of the product, tracking waypoints at each stage of manufacturing the product, a location of the vehicle 10 and/or the product in the production system 1601, by an input from an operator, or by one or more sensors monitoring the product and/or the production system 1601. As such, the footprint of the vehicle 10 may be automatically communicated to the pathing generation system 1600 at various stages of operation. The vehicle 10 may have a base footprint of the vehicle 10 alone, or the vehicle 10 may have a load footprint when the vehicle 10 is carrying one or more loads, such as a component of a product assembly, a part, a machine, a tool, etc. The footprint of the vehicle 10 may be taken into account by the pathing generation system 1600 when the pathing generation system 1600 is determining one or more possible paths the vehicle 10 could take. The vehicle 10 may not be able to travel in a substantially straight path from a current location of the vehicle 10 to the target location 1700a, for example along route 1704a, due to the footprint of the vehicle 10 and the obstacle 1702a. Instead, the pathing generation system 1600 may generate a route 1704b, which avoids the obstacle 1702a.

In some embodiments, the routes 1704 are generated incrementally, based on the floorplan 1602 and/or the signals from the sensors 112, such that a route to a second target location after a first target location is not determined until after the vehicle 10 is at or near the first target location. In some embodiments, based on signals from the sensors 112, the vehicle 10 may adjust a route 1704 or may switch from one route 1704 to another route 1704.

Referring still to FIG. 13, at the target location 1700a, the vehicle 10 may receive a first load 1706. The first load 1706 may change the footprint of the vehicle 10. For example, the first load 1706 may change the length, width, and/or height of the outer boundaries of the vehicle 10. The changed footprint may be monitored and or determined by the pathing generation system 1600 which may then adjust the one or more routes 1704 based on the updated footprint, as when the vehicle 10 is carrying the first load 1706, the vehicle 10 may need to operate differently. For example, the vehicle 10 may not be able to travel as closely to obstacles, walls, stations, humans, features, etc. or turn as sharply as the vehicle 10 may be able to without the first load 1706. In the embodiment of FIG. 13, the first load 1706 is configured to change at least the length of the footprint of the vehicle 10.

Near the exit of the target location 1700a, the production system 1601 may include an obstacle 1702b and an obstacle 1702c. In an embodiment where the vehicle 10 exits the target location 1700a without the first load 1706, the vehicle 10 alone may be able to travel along any number of paths around the obstacle 1702c, including by turning left and traveling between the target location 1700a and the obstacle 1702c, or turning right and passing along a right side portion of the obstacle 1702c. However, due to the change in footprint, when the vehicle 10 exits the target location 1700a with the first load 1706, the vehicle 10 may not be able to turn onto one or more of the possible paths. For example, the vehicle 10 carrying the first load 1706 may have a longer footprint (i.e., a length of the vehicle 10 is increased when the vehicle 10 is carrying the first load 1706). Due to the longer footprint, the vehicle 10 may not be able to make as sharply of a turn as when the vehicle 10 moves throughout the production system 1601 without any load. In some situations, the vehicle 10 could reverse one or more times to move into a position to maneuver a turn (e.g., a three-point turn, etc.). However, due to the longer footprint of the vehicle 10 carrying the first load 1706, the vehicle 10 may no longer be able to reverse to maneuver a turn. For example, as shown in FIG. 13, the obstacle 1702b may prevent the vehicle 10 from reversing due to the longer footprint of the vehicle 10 carrying the first load 1706. As such, the vehicle 10 may not be able to turn sharply enough to turn left and travel around a left side portion of the obstacle 1702c. Therefore, the vehicle 10 may need to travel around the right side portion of the obstacle 1702c by taking a route 1708b rather than the route 1708a or any other route which passes along the left side portion of the obstacle 1702c. It should be understood that reference to any particular arrangement of obstacles or left or right directional terms only serve to illustrate non-limiting examples of the operations of the vehicle 10 within the production system 1601.

The vehicle 10 may drive along the route 1708b to arrive at the target location 1700b. At the target location 1700b, the vehicle 10 may receive a second load 1710. The second load 1710 may change the footprint of the vehicle 10. For example, the second load 1710 may change the length, width, and/or height of the outer boundaries of the vehicle 10. The target location 1700b may be the next stage in a manufacturing process after the stage at target location 1700a. In some embodiments, the second load 1710 is a modification or addition to the first load 1706 that is added or performed at the target location 1700b. When the vehicle 10 is carrying the first load 1706 and the second load 1710, the vehicle 10 may need to operate differently. For example, the vehicle 10 may not be able to travel as closely to obstacles, walls, stations, humans, features, etc. or turn as sharply as the vehicle 10 may be able to without the second load 1710. In the embodiment of FIG. 13, the second load 1710 is configured to change at least the width of the footprint of the vehicle 10.

Near the exit of the target location 1700a, the production system 1601 may include an obstacle 1702d. In an embodiment where the vehicle 10 exits the location 170ba without the second load 1710, the vehicle 10 alone may be able to travel along any number of paths around the obstacle 1702d, including by turning right and passing around a left side portion of the obstacle 1702d, or by turning farther right and traveling between the target location 1700b and the obstacle 1702d. However, due to the change in footprint, when the vehicle 10 exits the target location 1700b with the second load 1710, the vehicle 10 may not be able to turn onto one or more of the possible paths. For example, the vehicle 10 carrying the second load 1710 may have a wider footprint (i.e., a width of the vehicle 10 is increased when the vehicle 10 is carrying the second load 1710). Due to the wider footprint, the vehicle 10 may or may not be able to make as sharply of a turn as when the vehicle 10 moves throughout the production system 1601 without any load. In the embodiment of FIG. 13, the vehicle 10 alone without any load, or the vehicle 10 carrying only the first load 1706, may be able to maneuver the turn to pass between the target location 1700b and the obstacle 1702d. However, due to the wider footprint of the vehicle 10 carrying the second load 1710, the second load 1710 may make the footprint too wide for the vehicle 10 carrying the second load 1710 to pass between the target location 1700b and the obstacle 1702d. As shown in FIG. 13, there may be sufficient space to allow the vehicle 10 carrying the first load 1706 and the second load 1710 to travel along a route 1712b between the obstacle 1702d and an obstacle 1702e to the target location 1700c.

In contrast to the embodiment described with respect to the obstacle 1702b potentially preventing the vehicle 10 from reversing to execute the left turn when exiting the target location 1700a, at the exit of the target location 1700b, in the embodiment of FIG. 13, there may be sufficient space to allow for the vehicle 10 to reverse. For example, the vehicle 10 alone without any load, or the vehicle 10 carrying only the first load 1706, may be able to reverse one or more times to move into a position to maneuver a turn (e.g., a three-point turn, etc.) between the target location 1700b and the obstacle 1702d because the production system 1601 provides sufficient space to accommodate the vehicle 10 reversing one or more times, even if the vehicle 10 is carrying the first load 1706. However, if the vehicle 10 is also carrying the second load 1710, even though the longer footprint will not prevent the vehicle 10 from maneuvering into a position to take a path which passes between the target location 1700b and the obstacle 1702d, the vehicle 10 still may not be able to take the route which passes between the target location 1700b and the obstacle 1702d because of the wider footprint of the vehicle 10 due to the second load 1710. Therefore, the vehicle 10 may need to travel around the left side portion of the obstacle 1702d by taking a route 1712b rather than the route 1712a or any other route which passes along the right side portion of the obstacle 1702d. It should be understood that reference to any particular arrangement of obstacles or left or right directional terms only serve to illustrate non-limiting examples of the operations of the vehicle 10 within the production system 1601.

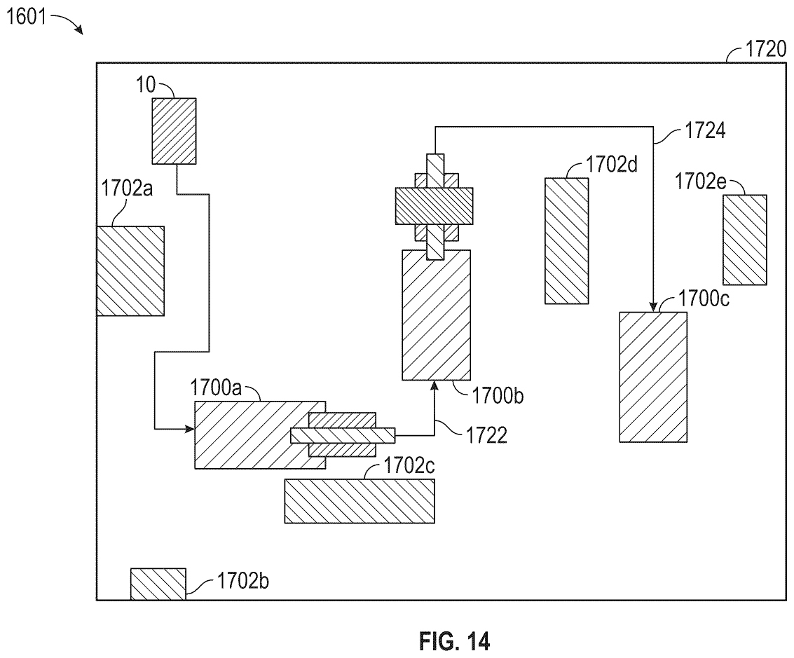

Turning now to FIG. 14, an optimized floorplan 1720 is shown. In some embodiments, the pathing generation system 1600 may generate the optimized floorplan 1720 as a recommended change from a current floorplan. In some embodiments, the pathing generation system 1600 may apply mapping data to optimize the locations 1700 layout in the optimized floorplan 1720. For example, the pathing generation system 1600 may be configured to identify and quantify (i.e., measure) locations 1700, obstacles 1702, the routes 1704 of other vehicles 10, and other areas in the production system 1601. In some embodiments, the pathing generation system 1600 can detect one or more stages of an assembly line and measure an area around the stages to define a target location 1700. The pathing generation system 1600 can analyze data gathered from the sensors 112, various floorplans, possible paths, generated routes, selected routes, traveled routes, locations, sizes, and shapes of obstacles, features, or stations (e.g., locations, etc.), and/or input from an operator or the input device to learn about and/or recognize inefficiencies within the production system 1601, including inefficiencies associated with the vehicle 10 traveling throughout the production system 1601. The pathing generation system 1600 may recommend changes and determine a more optimal configuration or arrangement for the production system 1601 (e.g., of the obstacles 1702, the target locations, the egress points, etc.) such as the optimized floorplan 1720, which optimizes the use of floor space, minimizes travel time for the vehicle 10 and maintains clear paths for vehicles, machines, robots, personnel, etc. The pathing generation system 1600 also records locations where the vehicle 10 becomes trapped and/or unable to move and stores the locations in a database on the memory 106 and in some embodiments also saves and stores the associated route the vehicle 10 was traveling on. A vehicle 10 passing the location where the vehicle 10 or another vehicle 10 was previously trapped or interfered with may adopt a new strategy for traversing around/through the location, such as a new route. The pathing generation system 1600 thus iteratively develops strategies for avoiding obstacles or passing over or around obstacles and determines preferences for successful strategies while avoiding failed strategies.

In some embodiments, the optimized floorplan 1720 may only be generated once or a small number of times in relation to the regular generation of floorplans by the pathing generation system 1600. In other words, the optimized floorplan 1720 may not be generated each and every time a floorplan is generated by the pathing generation system 1600. For example, the production system 1601 may already be operating under the most efficient possible configuration or arrangement.

As shown in FIG. 14, the optimized floorplan 1720 includes recommended changes such as a repositioning of one or more locations 1700 and/or obstacles 1702. In some embodiments, certain locations 1700 and/or obstacles 1702 may not be able to be moved or repositioned for various reasons, or it may not be desirable and/or necessary to move or reposition certain locations 1700 and/or obstacles 1702. For example, in the embodiment of FIG. 14, the target location 1700a and the target location 1700c may be moved, while none of the obstacles 1702 may be moved. In other embodiments, only obstacles 1702 may be moved, locations 1700 may not be moved, or both locations 1700 and obstacles 1702 may be moved.

In the embodiment of FIG. 14, the target location 1700a has been rotated counterclockwise substantially 90 degrees. In some embodiments, in addition to indicating a target location such as target location 1700a, each location 1700 may also include a target entry point into the location 1700 and a target exit point out of the location 1700. As such, with the target location 1700a rotated counterclockwise substantially 90 degrees, the vehicle 10 may exit the target location 1700a at a position that is substantially near the target location 1700b. The obstacle 1702b and the obstacle 1702c may no longer have much of an effect, if any, on the operation of the vehicle 10. The vehicle 10 may be able to travel substantially directly to the target location 1700b along the most efficient possible path (e.g., the shortest or fastest path, etc.), such as a route 1722, regardless of any load carried by the vehicle 10. It should be understood that reference to any particular arrangement of locations or directional terms only serve to illustrate non-limiting examples of the operations of the vehicle 10 within the production system 1601.

Additionally, the target location 1700c has been moved towards the obstacle 1702d and the obstacle 1702e. The pathing generation system 1600 may determine that, given the footprint of the vehicle 10 at the exit of the target location 1700b (e.g., the vehicle 10 is carrying the second load 1710), any route that passes between the target location 1700b and the obstacle 1702d will not be able to be traveled by the vehicle 10. As such, the pathing generation system 1600 may determine that it is acceptable to move the target location 1700c in a manner which blocks or further hinders a more efficient possible path (e.g., a route that passes between the target location 1700b and the obstacle 1702d) because the vehicle 10 will not take that possible path due to the footprint of the vehicle 10. By moving the target location 1700c towards the obstacle 1702d and the obstacle 1702e, a route 1724 may be able to be generated which shortens the distance and travel time between the target location 1700b and the target location 1700c. It should be understood that reference to any particular arrangement of locations or directional terms only serve to illustrate non-limiting examples of the operations of the vehicle 10 within the production system 1601.

In an embodiment in which the vehicle 10 exits the target location 1700b without the second load 1710 or without any load, it may still be preferable to move the target location 1700c towards the obstacle 1702d and the obstacle 1702e. Even though moving the target location 1700c towards the obstacle 1702d and the obstacle 1702e may block or further hinder a more efficient possible path (e.g., a route that passes between the target location 1700b and the obstacle 1702d) for the vehicle 10, because the vehicle 10 still has one or more possible paths to the target location 1700c (e.g., the route 1724), moving the target location 1700c towards the obstacle 1702d and the obstacle 1702e opens up a larger amount of space within the production system 1601 (e.g., in the lower right quadrant of the optimized floorplan 1720). An increase in space within the production system 1601 can be beneficial, allowing for better overall use of space within the production system 1601. As real estate generally holds great value, saving floor space and providing for a larger area for additional stations, machines, storage, personnel, etc. results in overall cost savings or greater profits.

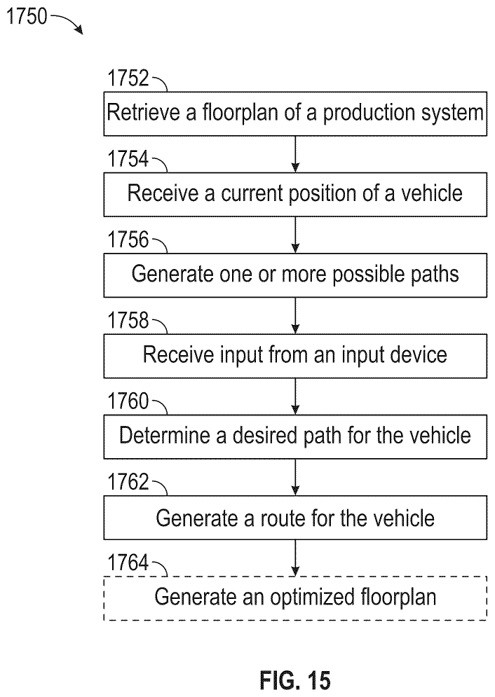

FIG. 15 depicts a process 1750 generally executed by the pathing generation system 1600. At step 1752, a floorplan (e.g., the floorplan 1602) of the production system 1601 may be retrieved by the pathing generation system 1600. The floorplan may be retrieved from a memory device, such as the memory 106 or mapped by the vehicle 10 using the sensors 112 The floorplan may include one or more locations 1700 which may be visited by the vehicle 10 and/or one or more obstacles 1702. At step 1754, the pathing generation system 1600 may receive a current location (e.g., current location 1603) of the vehicle 10. The current location of the vehicle 10 may be somewhere within the floorplan 1602 of the production system 1601. At step 1756, the pathing generation system 1600 may generate one or more possible paths (e.g., route 1704) for the vehicle 10 to visit one or more locations (e.g., locations 1700) throughout the production system 1601, taking into account the footprint of the vehicle 10 and the floorplan. The pathing generation system 1600 may display the one or more possible paths to an operator of the pathing generation system 1600 on the user interface.

At step 1758, the pathing generation system 1600 may receive one or more inputs from the input device. For example, the operator of the pathing generation system 1600 input a series of target locations and/or an order of approaching the target locations for the vehicle 10 throughout the production system 1601. As another example, the operator of the pathing generation system 1600 may edit the floorplan to include one or more of obstacles, locations, or egress points if the obstacle, location, or egress point is not already accounted for in the floorplan.

At step 1760, the pathing generation system 1600 may determine a desired path for the vehicle 10. For example, the desired path may avoid one or more obstacles. As another example, the desired path may be a most efficient path (e.g., the shortest or fastest path, etc.) for the vehicle 10. In some embodiments, the desired path may be automatically generated by the pathing generation system 1600. In other embodiments, the operator of the pathing generation system 1600 may provide input, such as an input selecting or preferring the desired path over any other possible path.

At step 1762, a route may be generated for the vehicle 10. The route may be the same as the desired path or it may vary. For example, in some embodiments, the desired path may be generated in combination with the possible paths generated in the step 1756 (e.g., prior to any input from the input device). Subsequent to the one or more inputs from the input device, the route generated for the vehicle 10 at the step 1762 may differ from the desired path. The vehicle 10 may then travel along the route generated at the step 1762. In some embodiments, the route may be updated while the vehicle is traveling along the route based on data from one or more sensors coupled to the vehicle (e.g., the sensors 112).

At step 1764, an optimized floorplan may be generated. For example, the pathing generation system 1600 may be configured to analyze data gathered from various floorplans, possible paths, generated routes, and/or input from an operator or the input device to learn about and/or recognize inefficiencies within the production system 1601, including inefficiencies associated with the vehicle 10 traveling throughout the production system 1601. In some embodiments, the optimized floorplan may only be generated once or a small number of times in relation to the regular generation of floorplans by the pathing generation system 1600. In other words, the optimized floorplan may not be generated each and every time a floorplan is generated by the pathing generation system 1600. For example, the production system 1601 may already be operating under the most efficient possible configuration or arrangement. Step 1764 is an optional step and may or may not be performed. In some embodiments, step 1764 is performed on its own based on mapping data provided to or obtained by the vehicle 10.

### Coordinated Motion System

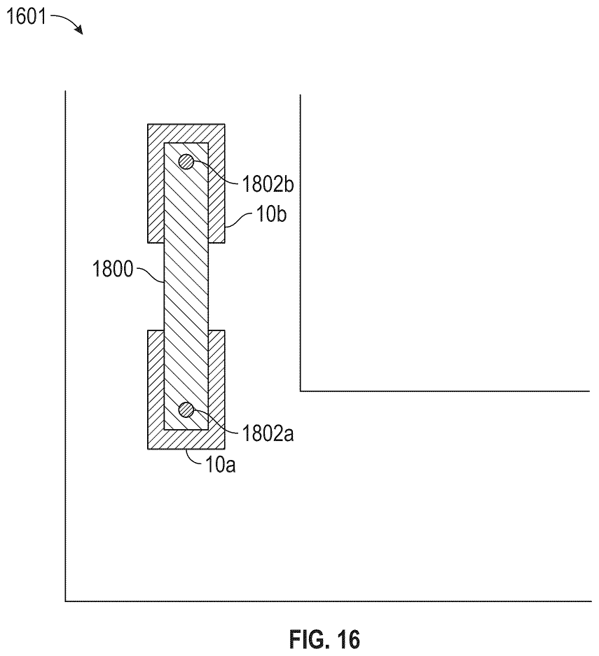

As shown in FIG. 16, one or more of the vehicles 10 may be used together within the production system 1601. For example, a vehicle 10a may be coupled to a vehicle 10b. The vehicle 10a may be coupled to the vehicle 10b via an electrical coupling, a wireless connection, or a physical coupling, or a load (e.g., load 1800, a component of a product assembly, a part, a machine, a tool, cart, etc.) may couple the vehicle 10a and the vehicle 10b via one or more coupling points (e.g., lifting implement 50, cart implement 60). The vehicle 10a and/or the vehicle 10b may have one or more cameras or sensors (e.g., distance sensors) which may assist in the positioning of the vehicle 10a and the vehicle 10b. For example, the cameras and/or sensors may communicate to maintain a specified or desired distance between the vehicle 10a and the vehicle 10b and/or to ensure that the vehicle 10a and the vehicle 10b do not collide.

The load 1800 may be coupled to the vehicle 10a and/or the vehicle 10b at one or more coupling points (e.g., coupling point 1802a, coupling point 1802b, etc.). The coupling point 1802a and the coupling point 1802b may be a component on the vehicle 10a or the vehicle 10b which is configured to secure the load 1800 in a fixed or rotatable manner (e.g., a turntable), or the coupling point 1802a and the coupling point 1802b may be a mechanism external to the load 1800 and the vehicle 10a and the vehicle 10b (e.g., a strap, a bolt, etc.). In some embodiments, the coupling points 1802 may be implements such as lifting implement 50 or cart implement 60. In some embodiments, the load 1800 may be large, bulky, unwieldy, etc., and one vehicle 10 may not be sufficient to support the load 1800 alone. In some embodiments, it may be preferable to have two or more of the vehicles 10 supporting the load 1800 to increase the maneuverability of the load amongst other benefits.

The vehicle 10a and the vehicle 10b may need to move through the production system 1601 in various ways, such as by making a turn around a corner, an obstacle, a station, etc. With respect to the embodiments previously described herein relating to the operation of the vehicle 10 within the production system 1601, the operation of the vehicle 10a and the vehicle 10b may be substantially similar or may differ. For example, the use of two or more vehicles, such as the vehicle 10a and the vehicle 10b, may increase difficulty of movement within the production system 1601.

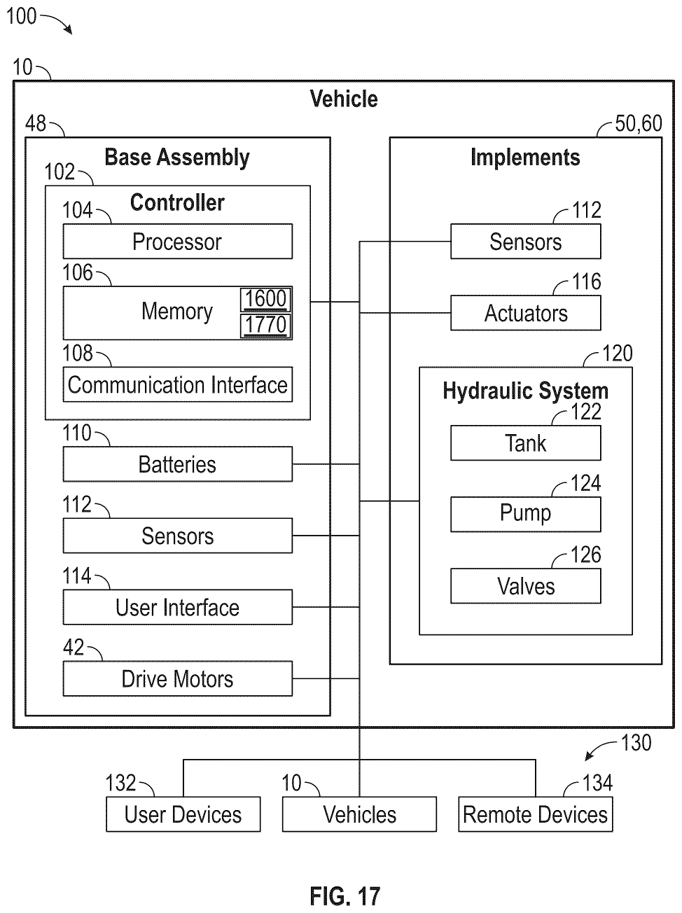

Referring now to FIG. 17, a coordinated motion system shown as coordinated motion system 1770 may coordinate movement of the vehicle 10a and the vehicle 10b. For example, the coordinated motion system 1770 may generate a series of coordinated motions between the vehicle 10a and the vehicle 10b to assist with movement of an assembly comprising the vehicle 10a, the vehicle 10b, and the load 1800. The coordinated motion system 1770 may communicate and operate with the pathing generation system 1600. For example, the coordinated motion system 1770 may provide input to and receive input from the pathing generation system 1600 with respect to the vehicle 10a and the vehicle 10b navigating turns, moving throughout the production system 1601, fitting between or around locations, obstacles, or features, etc. The coordinated motion system 1770 and the pathing generation system 1600 may have to take into account a footprint of the assembly including the vehicle 10a, the vehicle 10b, and the load 1800. In some embodiments, the pathing generation system 1600 may be included as part of the coordinated motion system 1770. In some embodiments, the coordinated motion system 1770 is included as part of a user device 132, or a remove device 134.

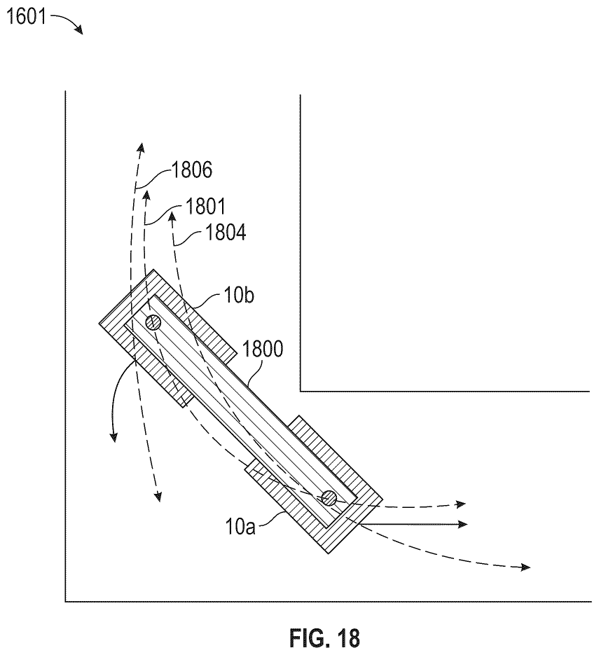

The coordinated motion system 1770 is configured to generate one or more paths or routes for one or more of the load 1800, the vehicle 10a, and the vehicle 10b. As shown in FIG. 18, in some embodiments, the coordinated motion system 1770 (i.e., the coordinated motion system 1770 and the pathing generation system 1600) determines a load route (e.g., load route 1801) for the load 1800, and then determines vehicle routes for the vehicle 10a (e.g., vehicle route 1804) and the vehicle 10b (e.g., vehicle route 1806) based on the route for the load 1800, such that as the vehicles 10a, 10b move along the vehicle routes, the combination or superposition of the vehicles routes results in the load 1800 moving along the load route. In some embodiments, the load route is based on the footprint of the vehicles 10a, 10b and the load 1800. In some embodiments, the vehicle routes also include orientation requirements, speeds, and drop, and/or pick up points, such that a route might include a vehicle dropping the load 1800, repositioning, and then picking up the load 1800 again to continue moving the load along the load route. In some embodiments, the vehicle route for the vehicle 10a is different from the vehicle route for the vehicle 10b. The different vehicle routes allow for independent articulation of each of the load 1800 to facilitate rotating the load around tight corners or obstacles (e.g., obstacles 1702). In some embodiments, in addition to generating the vehicle routes based on the load route, the vehicle routes may also be generated to satisfy one or more path conditions. The one or more path conditions may include predetermined separation distance between the vehicle 10a and the vehicle 10b, a speed minimum or maximum, a distance minimum or maximum, etc.

In FIG. 18, the vehicle 10a and the vehicle 10b are shown mid-turn. In the embodiment of FIG. 18, the vehicle 10a and the vehicle 10b may both be powered vehicles. In some embodiments, the vehicle 10a may be a primary vehicle such that the vehicle 10a controls the movement of the assembly and contains and/or communicates with the coordinated motion system 1770 and the pathing generation system 1600 while the vehicle 10b follows along. The vehicle 10b may still be powered and driving, but may not exert any control over the assembly and follows direction from the vehicle 10a. The vehicle 10a may include a greater number of cameras and/or sensors 112 and a greater amount of processing power than the vehicle 10b. As such, the vehicle 10b may be able to be produced at a lower cost. In some embodiments, a leader vehicle such as vehicle 10a may use the sensors 112 to monitor a position of a follower vehicle such as vehicle 10b while moving the load 1800. In other embodiments, the vehicle 10a and the vehicle 10b may both have at least some control over the movement of the assembly and may both communicate with the coordinated motion system 1770 and the pathing generation system 1600. In some embodiments, the follower vehicle may include sensors 112 to monitor a position of the load 1800, the vehicle 10a, and the vehicle 10b, and may be communicably coupled to the vehicle 10a. In some embodiments, the follower vehicle includes brakes which may be controlled by the follower vehicle itself or in some embodiments by the leader vehicle.

Alternatively, in the embodiment of FIG. 18, the vehicle 10a may be powered, while the vehicle 10b is not powered. In some embodiments, the vehicle 10b may be a dolly (i.e., a platform supported by a plurality of tractive elements), with or without any cameras, sensors, power, braking, steering, or capability of driving. In embodiments in which the vehicle 10b is a dolly, the coordinated motion system 1770 and the pathing generation system 1600 may instruct the vehicle 10a to travel in a manner which accounts for the movement of the vehicle 10b, similar to, for example, a trailer. The movement of the vehicle 10b as a dolly may be at least somewhat unexpected or unpredictable, and the coordinated motion system 1770 and the pathing generation system 1600 may have to make adjustments during operation of the assembly.

As shown in FIG. 18, one example of navigating a turn may include the vehicle 10a being fixedly coupled to the load 1800, and the load 1800 being fixedly coupled to the vehicle 10b. As such, the vehicle 10a may maintain a certain orientation with respect to the vehicle 10b, and the vehicle 10a and the vehicle 10b may maintain a certain orientation with respect to the load 1800. The vehicle 10a may drive forward in a substantially normal manner to navigate the turn. For example, the tractive elements of the vehicle 10a may turn to steer the vehicle 10a forward around the turn. The vehicle 10b may follow the vehicle 10a and the tractive elements 44 of the vehicle 10b may turn as necessary to accommodate the turn. For example, as shown in FIG. 16, the tractive elements 44 of the vehicle 10a may turn towards the left, while the tractive elements 44 of the vehicle 10b may turn towards the right. A rear end of the assembly (e.g., towards the vehicle 10b) may swing around the turn in a wider arc with respect to the turning of the vehicle 10a. The assembly may make a substantially wider turn than a single one of the vehicles 10. Accordingly, the vehicles 10a and 10b may follow separate routes to ensure the load 1800 follows a desired route.

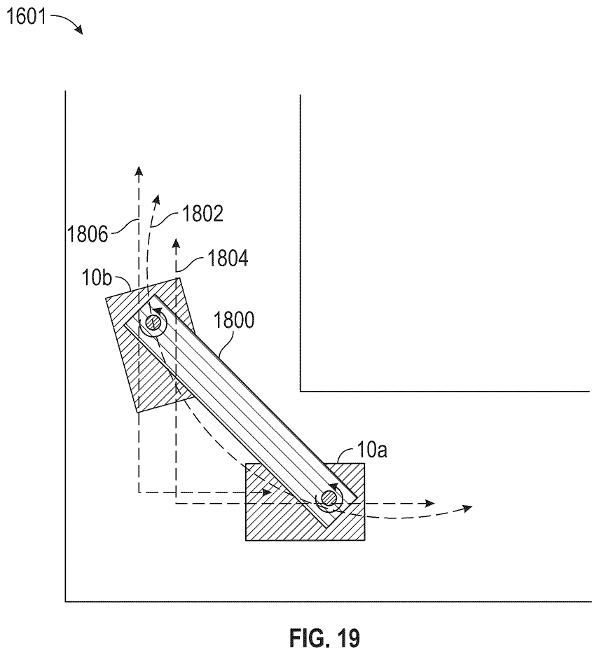

As shown in FIG. 19, another example of navigating a turn may include the vehicle 10a being movably coupled to the load 1800, and the load 1800 being movably coupled to the vehicle 10b. For example, the load 1800 may be rotatably coupled to the vehicle 10a and the vehicle 10b. The vehicle 10a and the vehicle 10b may both navigate the turn and may rotate with respect to the load 1800. In some embodiments, the vehicles 10a, 10b include one or more motors or actuators to cause the load 1800 rotate relative to the vehicle 10a, 10b or vice versa. In the embodiment of FIG. 19, the tractive elements 44 of the vehicle 10a turn to the left to make the turn and the tractive elements 44 of the vehicle 10b also turn to the left to make the turn. The vehicle 10b may follow along substantially the same path as the vehicle 10a (e.g., the vehicle route 1804 and the vehicle route 1806 may be substantially the same). For example, the vehicle 10a and the vehicle 10b may both be powered and may both drive along the route independently. The load 1800 may move along the load route 1801 as the vehicle 10a drives along the vehicle route 1804 and the vehicle 10b drives along the vehicle route 1806.

In the embodiment of FIG. 19, the movement of the vehicle 10b with respect to the movement of the vehicle 10a may not be as much of a concern with respect to the movement of the assembly due to the rotatable coupling of the load 1800 to the vehicle 10a and the vehicle 10b as the vehicle 10a and the vehicle 10b are both capable of driving and navigating turns independently. Instead, the footprint of the assembly may affect the movement of the assembly to a greater degree, as the load 1800 may cause the assembly to have a varied footprint throughout the production system 1601. As shown in FIG. 19, because the vehicle 10a and the vehicle 10b have rotated with respect to the load 1800, there is a greater risk that a central portion of the load 1800 may collide with a corner or protrusion and become stuck on the corner or protrusion.

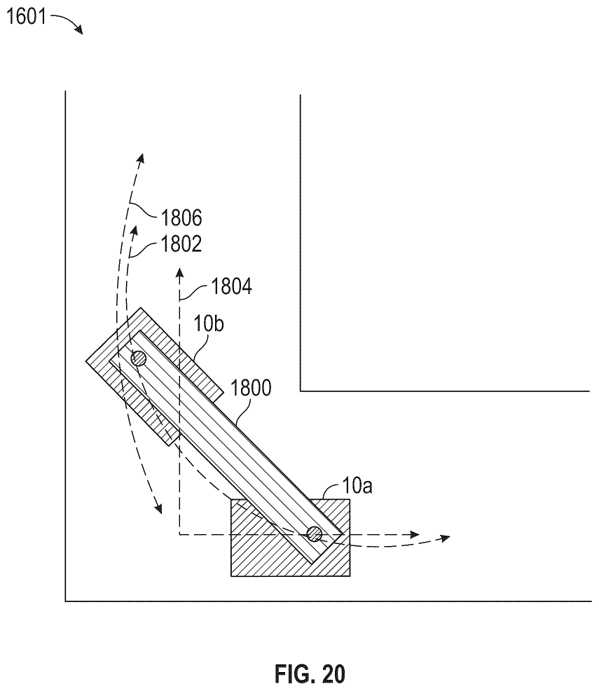

As shown in FIG. 20, another example of navigating a turn may include the vehicle 10a being movably coupled to the load 1800, and the load 1800 being fixedly coupled to the vehicle 10b. The vehicle 10b may be powered or unpowered, or may be a dolly. The vehicle 10a generally navigates through the production system 1601 taking into account the footprint of the assembly and the movement of the vehicle 10b. As depicted in FIG. 20, the vehicle 10a may rotate with respect to the load 1800 to navigate the turn, while the vehicle 10b follows along. For example, the vehicle 10a may make a left turn, such as along the vehicle route 1804, while the vehicle 10b follows along, such as along the vehicle route 1806, moving in a wider arc with respect to the left turn. Accordingly, the load 1800 may be moved along the load route 1801.

As shown in FIGS. 18-20, a path or route for the load 1800, such as the load route 1801, may be determined between two locations (e.g., stations, etc.) or positions in order to advance the load 1800 from a first position to a second position. The vehicle route 1804 and the vehicle route 1806 may be generated based on the load route 1801. The motion of the vehicle 10a along the vehicle route 1804 and the motion of the vehicle 10b along the vehicle route 1806 results in the load 1800 moving along the load route 1801.

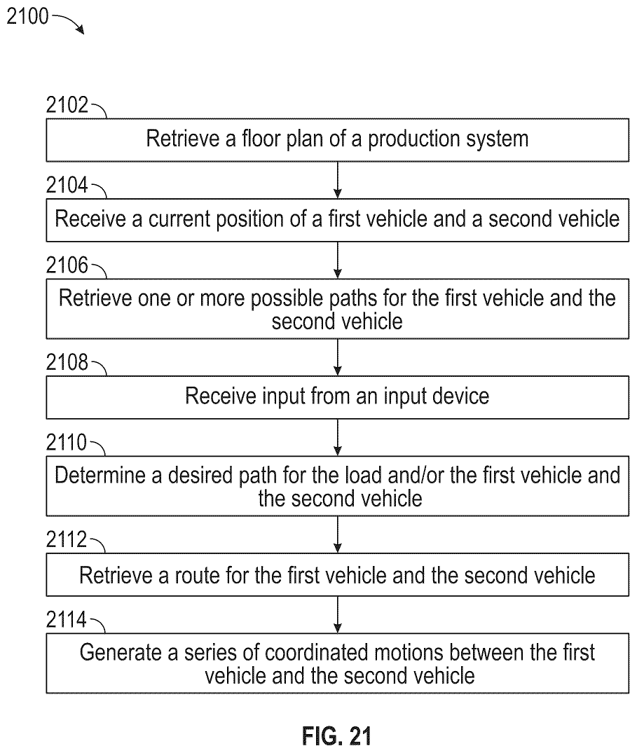

Turning now to FIG. 21, a process 2100 which may be executed by the coordinated motion system 1770 is shown. At step 2102, a floorplan (e.g., the floorplan 1602) of the production system 1601 may be retrieved by the coordinated motion system 1770. The floorplan may be retrieved from a memory device, such as the memory 106 or be mapped and/or determined by the vehicle 10. The floorplan may include one or more locations which may visited by the vehicle 10a and the vehicle 10b and/or one or more obstacles. At step 2104, the coordinated motion system 1770 may receive a current position of the vehicle 10a and/or the vehicle 10b. The current position of the vehicle 10a and/or the vehicle 10b may be located somewhere within the floorplan of the production system 1601. At step 2106, the coordinated motion system 1770 may receive or retrieve, from the pathing generation system 1600, one or more possible paths for the vehicle 10a and the vehicle 10b to visit one or more locations throughout the production system 1601, taking into account the footprint of the vehicle 10a, the vehicle 10b, the load 1800, and the floorplan.

At step 2108, the coordinated motion system 1770 may receive or retrieve, from the pathing generation system 1600, the one or more inputs from one or more of the input devices. For example, the operator may input a series of stops and/or an order of the series of stops for the vehicle 10a and the vehicle 10b at various locations throughout the production system 1601. As another example, the operator may edit the floorplan to include one or more of obstacles if the obstacle is not already accounted for in the floorplan. The one or more input devices also may communicate the footprint of the vehicle 10 to the pathing generation system 1600 at various stages of operation of the vehicle 10.

At step 2110, the pathing generation system 1600 may determine a desired path for the load 1800 and/or the vehicle 10a and the vehicle 10b, taking into account the footprint of the vehicle 10a, the vehicle 10b, and the load 1800. For example, the desired path may avoid one or more obstacles. As another example, the desired path may be a shortest path, a fastest path, or a most efficient path for the vehicle 10a and the vehicle 10b. In some embodiments, the desired path for the vehicles 10a, 10b is based on the desired path for the load 1800. The desired path may be communicated from the coordinated motion system 1770 to the pathing generation system 1600. In some embodiments, the desired path may be automatically generated by the coordinated motion system 1770 which may include the pathing generation system 1600. In other embodiments, the operator may provide input, such as an input selecting or preferring the desired path over any other possible path.

At step 2112, the coordinated motion system 1770 may receive or retrieve, from the pathing generation system 1600, a route for the vehicle 10a and the vehicle 10b. The route may be the same as the desired path or it may vary. For example, in some embodiments, the desired path may be generated in combination with the possible paths generated in the step 2106 (e.g., prior to any input from the input device). Subsequent to the one or more inputs from the input device, the route generated for the vehicle 10 at the step 2112 may differ from the desired path.

At step 2114, the coordinated motion system 1770 may generate a series of coordinated motions between the vehicle 10a and the vehicle 10b based on the route and the one or more inputs. In some embodiments, the series of coordinated motions in combination result in the load 1800 moving along the desired load path. For example, the coordinated motion system 1770 may instruct the vehicle 10a to drive in a specified manner, as previously described herein. The coordinated motion system 1770 may or may not instruct the vehicle 10b to drive in a specified manner based on the instructions provided to the vehicle 10a. Generating the series of coordinated motions between the vehicle 10a and the vehicle 10b may include changing a position of one or more of the vehicle 10a relative to the vehicle 10b or the vehicle 10b relative to the vehicle 10a along at least a portion of the route. Generating the series of coordinated motions between the vehicle 10a and the vehicle 10b may also include avoiding obstacles and maintaining a distance between the vehicle 10a and the vehicle 10b along at least a portion of the route.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the production system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system, comprising:
a first vehicle and a second vehicle coupled with each other, the first vehicle and second vehicle configured to support a load; and
one or more memory devices storing instructions thereon, that, when executed by one or more processors, cause the one or more processors to:
obtain one or more locations in a floorplan of a production system;
obtain a route for the first vehicle and the second vehicle, from a first current position of the first vehicle and a second current position of the second vehicle to the one or more locations; and
generate a series of coordinated motions between the first vehicle and the second vehicle based on the route.

2. The system of claim 1, wherein the first vehicle and the second vehicle are coupled with each other communicatively, the first vehicle and the second vehicle configured to communicate with each other and operate to maintain a specific distance between each other.

3. The system of claim 1, wherein the second vehicle is coupled to the first vehicle by the load, the load extending between and supported by the first vehicle and the second vehicle.

4. The system of claim 1, wherein the first vehicle is powered and the second vehicle is unpowered.

5. The system of claim 1, wherein the one or more processors are configured to generate the series of coordinated motions between the first vehicle and the second vehicle based on a footprint of the first vehicle, the second vehicle, and the load, and the floorplan of the production system such that the first vehicle, the second vehicle, and the load avoid one or more obstacles indicated by the floorplan.

6. The system of claim 1, wherein the one or more processors are configured to generate the series of coordinated motions between the first vehicle and the second vehicle such that the first vehicle and the second vehicle maintain a distance between each other along at least a portion of the route.

7. The system of claim 1, wherein generating the series of coordinated motions between the first vehicle and the second vehicle comprises changing at least one of a position or orientation of the first vehicle relative to the second vehicle or the second vehicle relative to the first vehicle along at least a portion of the route.

8. A method of controlling a plurality of vehicles, the method comprising:
obtaining one or more locations in a floorplan of a production system;
obtaining a route for a first vehicle and a second vehicle from a current position to the one or more locations, the first vehicle and the second vehicle coupled with each other and configured to support a load;
generating a series of coordinated motions between the first vehicle and the second vehicle based on the route; and
controlling the first vehicle and the second vehicle to perform the series of coordinated motions along the route to transport the load to the one or more locations.

9. The method of claim 8, wherein generating the series of coordinated motions between the first vehicle and the second vehicle based on the load avoids one or more obstacles indicated by the floorplan.

10. The method of claim 8, wherein generating the series of coordinated motions between the first vehicle and the second vehicle comprises maintaining a distance between each other along at least a portion of the route.

11. The method of claim 8, wherein generating the series of coordinated motions between the first vehicle and the second vehicle comprises changing at least one of a position or orientation of the first vehicle relative to the second vehicle or the second vehicle relative to the first vehicle along at least a portion of the route.

12. A system, comprising:
a first vehicle;
a second vehicle; and
one or more memory devices storing instructions thereon, that, when executed by one or more processors, cause the one or more processors to:
determine a load route for a load supported by the first vehicle and the second vehicle between a first position and a second position;
generate a first vehicle route for the first vehicle based on the load route and a second vehicle route for the second vehicle based on the load route;
wherein motion of the first vehicle along the first vehicle route and the second vehicle along the second vehicle route results in the load moving along the load route.

13. The system of claim 12, wherein the first vehicle is coupled to the second vehicle communicatively, the first vehicle and the second vehicle configured to communicate with each other and operate to maintain a specific distance between each other.

14. The system of claim 12, wherein the second vehicle is coupled to the first vehicle through the load, the load extending between and supported by the first vehicle and the second vehicle.

15. The system of claim 12, wherein the one or more processors are configured to turn tractive elements of the first vehicle in a first direction to move the first vehicle along the first vehicle route and turn tractive elements of the second vehicle in a second direction to move the second vehicle along the second vehicle route.

16. The system of claim 12, wherein generating the first vehicle route for the first vehicle based on the load route and generating the second vehicle route for the second vehicle based on the load route comprises generating a series of coordinated motions between the first vehicle and the second vehicle.

17. The system of claim 12, wherein the one or more processors are configured to generate the first vehicle route for the first vehicle and the second vehicle route for the second vehicle based on the load route, a footprint of the first vehicle, the second vehicle, and the load, and a floorplan of a production system such that the first vehicle, the second vehicle, and the load avoid one or more obstacles indicated by the floorplan.

18. The system of claim 12, wherein the one or more processors are configured to generate a series of coordinated motions between the first vehicle and the second vehicle such that the first vehicle and the second vehicle maintain a distance between each other along at least a portion of the load route.

19. The system of claim 12, wherein the one or more processors are configured to generate a series of coordinated motions between the first vehicle and the second vehicle based on the load route, the series of coordinated motions comprising changing a position of one or more of the first vehicle relative to the second vehicle or the second vehicle relative to the first vehicle along at least a portion of the load route.

20. The system of claim 12, wherein the one or more processors are configured to generate the load route between the first position and the second position based on a footprint of the first vehicle, the second vehicle, and the load, and a floorplan of a production system such that the first vehicle, the second vehicle, and the load avoid one or more obstacles indicated by the floorplan.
